(19) United States
(12) Patent Application Publication
(10) Pub. No.: US 2007/0057497 A1
(43) Pub. Date: Mar. 15, 2007

(54) Gas bag module

(75) Inventors: Ralph Frisch, Mombris (DE); Klaus Freudenberger, Aschaffenburg (DE); Michael Schneider, Sulzbach (DE); Andreas Kienzner, Wiesen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/519,337

(22) Filed: Sep. 12, 2006

(30) Foreign Application Priority Data
Sep. 13, 2005 (DE) 20 2005 014 442.8

(51) Int. Cl. B60R 21/217; B60R 21/26

(52) U.S. Cl. 280/740; 280/728.2

(57) ABSTRACT

In a gas bag module with a gas bag, a diffusor cage which has outflow openings to the gas bag, a gas generator and a mounting part surrounding the gas generator are provided. The gas generator is arranged beneath the diffusor cage and held in the gas bag module by the mounting part. Permanently open discharge openings leading away from the gas bag are provided in the mounting part. The gas produced by the gas generator flows out of a space enclosed by the diffusor cage, the mounting part and the gas generator through the discharge openings.

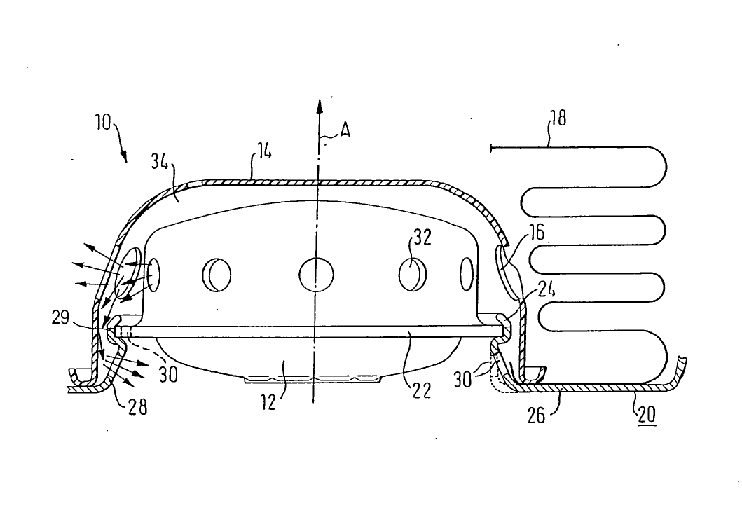

### FIELD OF THE INVENTION

The invention relates to a gas bag module.

### BACKGROUND OF THE INVENTION

In a gas bag module, often a diffusor cage is arranged in order to provide an intermediary space between the gas generator and the gas bag, and among other things, to prevent contact of the gas bag fabric with the hot gas generator.

In the standard case, when the gas bag module is activated, the gas bag is inflated by the gas produced by the gas generator, the gas bag unfolding. Situations can arise, however, in which gas should not at first pass into the gas bag at all, but should be discharged from the gas bag module as early as possible into the adjacent area.

It is an object of the invention to increase the safety of a gas bag module for a vehicle occupant.

### BRIEF SUMMARY OF THE INVENTION

To achieve this, in a gas bag module comprising a gas bag, a diffusor cage which has outflow openings to the gas bag, a gas generator and a mounting part surrounding the gas generator, the gas generator is disposed beneath the diffusor cage and held on the gas bag module side, i.e. is attached to the remainder of the module by the mounting part. Permanently open discharge openings leading away from the gas bag are provided in the mounting part. The gas produced by the gas generator flows out of a space enclosed by the diffusor cage, the mounting part and the gas generator through the discharge openings. The gas thus passes directly from the gas generator to the discharge openings without any long distances. By means of this arrangement, the discharge openings are moreover protected from being covered by sections of the folded gas bag. In this way it is also guaranteed that even before opening a module housing or a covering cap upon ignition of the gas generator, the gas produced by the latter can flow out of the gas bag module into the adjacent area.

Preferably, the discharge openings lie within the space defined by the diffusor cage.

According to a preferred embodiment, the mounting part is a component of a generator support separate from the gas generator. The mounting part can be an integral component of a module housing, e.g. of a generator support forming the base of a module housing.

Alternatively, the mounting part is formed by a generator flange.

In order to make optimal use of the available space, e.g. in a steering wheel hub, the discharge openings can lie in a section of the mounting part which is oriented at an angle or parallel to an axis of the gas bag module. In this case, at least components of the gas flow are oriented parallel to the base of the gas generator so that a direct impingement on one of the gas bag module or vehicle components directly adjacent to the discharge opening and a gas accumulation connected thereto is avoided.

The discharge openings can be disposed e.g. in a base of the gas bag module.

The gas passes through the discharge openings not into the gas bag, but preferably directly into an area adjacent to the gas bag module.

### BRIEF DESCRIPTION OF THE DRAWING

The only FIGURE shows a schematic section through a gas bag module according to the invention.

### DETAILED DESCRIPTION OF A PREFERRED EMBODIMENT

The FIGURE shows a gas bag module 10 which in the example shown is designed to be accommodated in a steering wheel, with a gas generator 12. The gas generator 12 is disposed beneath a diffusor cage 14 which has a series of outflow openings 16 which are disposed around a cylindrical wall of the diffusor cage 14. The outflow openings 16 form a flow connection between the gas generator 12 and a gas bag 18, which before actuation of the gas bag module 10 is accommodated, folded, in a module housing 20 that is only suggested in the FIGURE. The module housing 20 is closed by a covering cap (not shown) which in the standard case is opened upon actuation of the gas bag module in order to allow the gas bag 18 to exit from the gas bag module 10 so that it can unfold into its desired position.

The gas generator 12 has a generator flange 22 which before assembly of the gasbag module is already securely, in this example integrally, connected to the gas generator 12 and fully surrounds the latter around its circumference. A generator support 24 having a recess into which the gas generator 12 is inserted with the generator flange 22 contacting the generator support 24, attaches the gas generator 12 in the gas bag module. In the example shown, the generator support 24 is an integral component of the module housing 20 and among other things, also forms a base 26 of the module housing 20. The gas generator 12 is therefore surrounded by a mounting part which is formed here by the generator support 24 and the generator flange 22.

The generator support 24 has an annular section 28 which is approximately in the shape of a truncated cone. In the example shown, the section 28 is lying beneath the generator flange 22. The wall of the section 28 therefore stands at an angle of more than 0° to an axis A of the gas bag module 10 which in this case also coincides with the unfolding direction of the gas bag 18, the point of the truncated cone pointing in direction of the axis A.

In the inclined section 28 of the generator support 24 several permanently open discharge openings 30 are formed which are in direct flow connection with an adjacent area of the gas bag module 10.

The wall of the section 28 could alternatively be arranged vertically, as shown in dashed lines on the right hand side of the FIGURE, with the discharge openings 30 oriented in parallel to the axis A.

The discharge openings 30 lie within the diffusor cage 14, i.e. radially within the space enclosed by the diffusor cage 14.

An edge of the diffusor cage 14 lies adjacent to the base 26 of the module housing 20, outside of the annular section 28. A gas introduction opening of the gas bag 18 is clamped between the edge of the diffusor cage 14 and the base 26 of the module housing 20. The gas bag 18 is, therefore, arranged with distance to the discharge openings 30 and is kept away from the discharge openings 30 by the diffusor cage 14.

When the gas bag module 10 is actuated, the gas generator 12 produces gas which flows out of outlet openings 32 in the circumferential wall of the gas generator 12. The gas first of all passes into a space 34 enclosed by the diffusor cage 14, the gas generator 12 and the mounting part comprising the generator flange 22 and the generator support 24. From here the gas can pass through the outflow openings 16 in the diffusor cage 14 (which are also permanently open) into the gas bag 18. By means of the discharge openings 30 there is, however, also a direct flow connection between the space 34 and the adjacent area of the gas bag module 10 through which the gas can flow out of the space 34 away from the gas bag 18 directly out of the gas bag module 10. This is e.g. required when the gas generator 12 is ignited under conditions in which opening of the covering cap is not desired. In this case, all of the gas produced by the gas generator 12 can leave the gas bag module 10 through the discharge openings 30. The gas flows are identified in the left hand half of the FIGURE by arrows.

In another embodiment, the discharge openings 30 are formed in the generator flange 22, as suggested by dashed lines in the left hand half of the FIGURE.

As shown here, the mounting part can consist of a combination of the generator flange 22 and the generator support. However, it can also be formed by just the generator flange 22 or by just the generator support 24. The outflow openings 30 can be disposed in any suitable section of the mounting part.

In the example shown, the annular section 28 is integrally formed with the generator flange 22. The annular section 28 continues here directly into a fastening section 29 grasping the edge of the generator flange 22 and thus attaches the gas generator 12 to the generator support 24.

The gas generator 12 can also be connected directly, e.g. by means of the generator flange 22, to the module housing or to a component fixed to the vehicle. In order to attach the generator flange 22 and/or the generator support 24 to the module housing 20 or directly to a component fixed to the vehicle, conventional screwing bolts can for example also be used.

1. A gas bag module comprising:
a gas bag (18),
a diffusor cage (14) which has outflow openings (16) to the gas bag (18),
a gas generator (12) and
a mounting part surrounding the gas generator (12) having permanently open discharge openings (30) leading away from the gas bag (18),
the gas generator (12) being arranged beneath the diffusor cage (14) and held in the gas bag module by the mounting part,
wherein gas produced by the gas generator (12) flows out of a space (34) enclosed by the diffusor cage (14), the mounting part and the gas generator (12) through the discharge openings (30).

2. The gas bag module according to claim 1, wherein the discharge openings (30) lie within the space (14) defined by the diffusor cage.

3. The gas bag module according claim 1, wherein the mounting part is a component of a generator support (24) separate from the gas generator (12).

4. The gas bag module according to claim 3, wherein the mounting part is an integral component of a module housing (20).

5. The gas bag module according to claim 1, wherein the mounting part is a generator flange (22).

6. The gas bag module according to claim 1, wherein the discharge openings (30) lie in a section of the mounting part which is oriented at an angle to an axis (A) of the gas bag module (10).

7. The gas bag module according to claim 1, wherein the discharge openings (30) lie in a section of the mounting part which is oriented parallel of more than 0° to an axis (A) of the gas bag module (10).

8. The gas bag module according to claim 1, wherein the discharge openings (30) are disposed in a base (26) of the gas bag module (10).

9. The gas bag module according to claim 1, wherein gas flows directly out of the gas bag module (10) through the discharge openings (30).
